(19) United States
(12) Patent Application Publication
(10) Pub. No.: US 2025/0232154 A1
(43) Pub. Date: Jul. 17, 2025

(54) PARTITIONING-BASED SCALABLE WEIGHTED AGGREGATION COMPOSITION FOR KNOWLEDGE GRAPH EMBEDDING

(71) Applicant: MASTERCARD TECHNOLOGIES CANADA ULC, Vancouver (CA)

(72) Inventors: Sarthak MALIK, Muzaffarnagar (IN); Esam ABDEL-RAHEEM, Windsor (CA); Anil Kumar SURISETTY, Visakhapatnam (IN); Aakarsh MALHOTRA, NEW DELHI (IN); Sudipta MODAK, Windsor (CA)

(73) Assignee: MASTERCARD TECHNOLOGIES CANADA ULC, Vancouver (CA)

(21) Appl. No.: 19/020,656

(22) Filed: Jan. 14, 2025

(30) Foreign Application Priority Data
Jan. 15, 2024 (IN) 202441002960

(51) Int. Cl. G06N 3/042; G06N 3/045; G06N 3/0464; G06N 3/096

(52) U.S. Cl. CPC G06N 3/042; G06N 3/045; G06N 3/0464; G06N 3/096

(57) ABSTRACT

The disclosure relates to methods and systems of partitioning-based scalable weighted aggregation composition for embeddings learned from knowledge graphs for training neural networks to perform downstream machine-learning tasks. For example, a system may access a knowledge graph comprising a plurality of nodes and partition the knowledge graph into a plurality of partitions based on edge densities between nodes of the knowledge graph. The system may perform partition-wise encoding using compositional message passing between nodes that enables learning from neighboring nodes. The system may generate an embedding for each node and each relation type in each partition based on the partition-wise encoding using compositional message passing. The system may concatenate the generated embeddings from the plurality of partitions. The system may train a global neural network for a downstream prediction task based on the concatenated embeddings using one or more weight matrices.

### RELATED APPLICATIONS

This application claims priority to Indian Provisional Patent Application No. 202441002960, filed on Jan. 15, 2024, entitled “Partitioning-Based Scalable Weighted Aggregation Composition for Knowledge Graph Embedding,” the content of which is incorporated by reference in its entirety herein.

### BACKGROUND

A knowledge graph (KG) is a semantic network which can be regarded as a diverse multigraph consisting of more than one type of directed relation. Each KG contains a collection of facts that are organized within a certain structure that represents a group of linked entities represented as nodes in the graph and their semantic descriptions. The linkage between entities may be represented as edges in the graph. While KGs can represent relationships between entities, they are usually incomplete. Therefore to complete these graphs, Knowledge graph embedding (KGE) may need to be performed to learn embeddings from the graph topology and then using the embeddings to predict relations between entities using machine learning techniques. KGE is considered a foundation for several types of machine learning tasks using KGs.

However, KGE consumes a lot of GPU memory and requires an immense amount of time to train, making the process highly complex and non-scalable. Typically, parallelization strategies may be ineffective because they may disrupt the structure of a KG, resulting in the loss of the ability to effectively learn embeddings and draw inferences from the graph. These and other issues may exist when using KGs for machine learning systems, including training neural networks to perform downstream tasks.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment of partitioning-based scalable weighted aggregation composition for embeddings learned from knowledge graphs for training neural networks to perform link prediction or other downstream tasks;

FIG. 2A illustrates a schematic example of partitioning a knowledge graph and performing partition-wise encoding to generate partition-specific embeddings for training a neural network;

FIG. 2B illustrates a schematic example of concatenating the partition-specific embeddings for training and retraining neural networks to perform link prediction;

FIG. 3 illustrates an example of a method for partitioning-based scalable weighted aggregation composition for embeddings learned from knowledge graphs for training neural networks to perform link prediction or other downstream tasks.

FIG. 4 illustrates an example of a method for partitioning a knowledge graph;

FIG. 5 illustrates an example of a method of performing weighted average composition convolution to learn embeddings;

FIG. 6 illustrates an example of a method of concatenating the embeddings learned from each partition;

FIG. 7 illustrates an example of a method for generating knowledge graph embeddings using partitioning-based scalable weighted aggregation composition;

FIG. 8 illustrates a schematic diagram of an example of a training and testing pipeline for assessing the performance of baseline modeling and the partition-based scalable Weighted Aggregation Composition (WAC) convolution and merging described herein;

FIG. 9 illustrates plots of performance of various datasets with different numbers of partitions produced using Lovain Constellation Partitioning (LCP) and global merging;

FIG. 10 illustrates a plot of number of partitions versus performance improvement (speedup) in a speedup evaluation of LPC and WAC with parallelization; and

FIG. 11 illustrates an example of a computer system that may be implemented by devices illustrated in FIG. 1.

### DETAILED DESCRIPTION

The disclosure relates to methods and systems of generating knowledge graph embeddings for training neural networks to perform downstream tasks such as link prediction. A system may use improved Louvain Constellation Partitioning for heterogeneous KGs leading to reduced training time by leveraging the local graph structure to partition KGs without disrupting the structure. In particular, the system may use modularity maximization to generate tight communities of nodes with partitioning that minimizes lost links between entities, thereby retaining the original topology or structure of the original KG. The system may also use improved composition message passing based on Weighted Aggregation composition (WAC) convolution, which uses two aggregation functions: one for self-loop and another for messages from its neighbors. WAC convolution enables effective learning from neighboring nodes. In particular, the system may use an improved compositional-Graph Neural Network (GNN) algorithm, including the WAC coupled with a multiplication operation and a 1-dimensional convolutional network that takes advantage of feature, entity, and relation specific weights to learn effective embeddings. To process results of partitioning and parallelization, the system may use an improved global decoder framework that can use node and relationship embeddings from different partitions to achieve global level inferences. The foregoing not only speeds up the training process, but also preserves the original topology of the graph and increases the overall accuracy of link prediction and other machine learning (ML) tasks compared to other methods that employ partitioning to train knowledge graphs. Having described an overview of examples of operation of the detecting anomalies, attention will now turn to an example of a system environment in which anomalies may be detected.

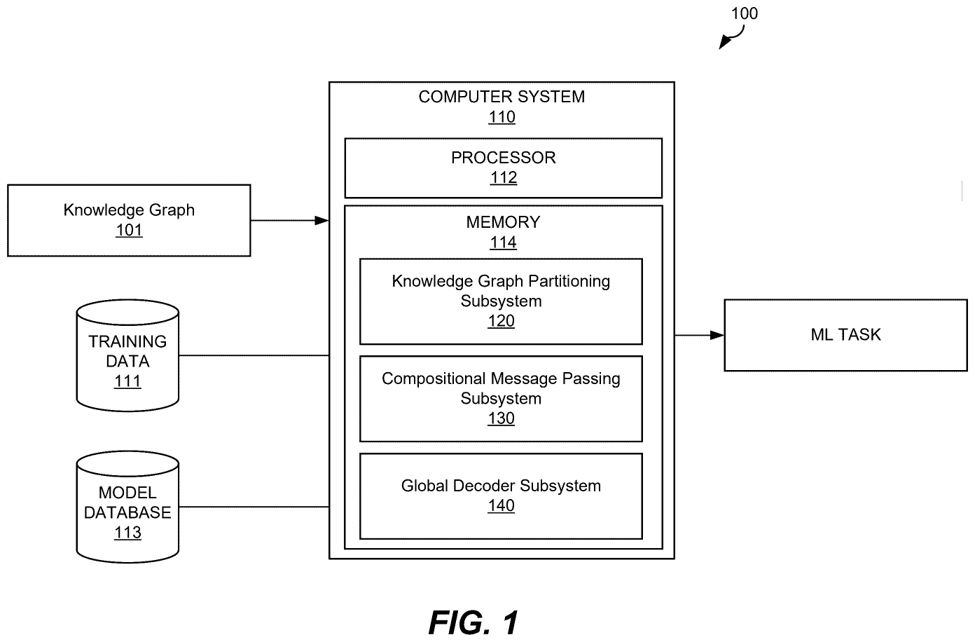

FIG. 1 illustrates an example of a system environment 100 of partitioning-based scalable weighted aggregation composition for embeddings learned from a knowledge graph 101 for training neural networks to perform link prediction or other downstream tasks. The system environment 100 may include a computer system 110 that trains neural networks to generate a prediction such as a link prediction that predicts whether or not two entities are linked. At least some of the components of the system environment 100 may be connected to one another via a communication network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

The training database 111 may store one or more training datasets used for training. Examples of the training dataset may include knowledge graphs, open source training datasets, such as those listed in Table 2 and/or other training data. The model database 113 may store results of training (such as weight matrices, learned embeddings, or other data learned from the training datasets), model hyperparameters, and/or other data relating to training as described herein.

The computer system 110 may include one or more computing devices that generate embeddings from a knowledge graph 101 for training neural networks. For example, the one or more computing devices of the computer system 110 may each include a processor 112, a memory 114, a knowledge graph partitioning subsystem 120, a compositional message passing subsystem 130, a global decoder subsystem 140, and/or other components. The knowledge graph partitioning subsystem 120, the compositional message passing subsystem 130, and the global decoder subsystem 140 may each be implemented as instructions that program the processor 112. Alternatively, or additionally, the knowledge graph partitioning subsystem 120, the compositional message passing subsystem 130, and the global decoder subsystem 140 may each be implemented in hardware.

A knowledge graph 101 is a semantic network that includes entities (E) and can be represented as KG={E, R, T}, in which E, R, and T represent entities, relations, and triples, respectively. The triples in a knowledge graph 101 can be represented as T={h, r, t} in which h, r, and t represent the head, relation, and tail, respectively. The relations in a KG are directed and represent a link between head and tail entities. A head entity is an object entity and a tail entity is a target entity. These entities may define roles in the relationship shared between the pair of entities. For example, a triple {“John Do account no. 1234”, “purchase transaction from”, “ABC co.”} may include a head entity “John Do account no. 1234” (a cardholder and account) having a relation made a “purchase transaction from” the tail entity “ABC co.” This triple therefore defines a purchase transaction relationship in which the head entity John Do made a purchase from a tail entity “ABC co.” The roles may be switched depending on particular implementations. For example, “ABC co.” could be the head entity and “John Do” could be the tail entity. For example, the triple {“ABC co.”, “refund transaction”, “John Do account. No. 1234”} may specify that the head entity ABC co. made a refund transaction with the tail entity “John Do account. No. 1234.” It should be noted that the relation may be typed. That is, there may be different types of relationships between head and tail entities.

The particular types of entities and their relations will vary depending on the particular context in which the computer system 110 is implemented. For example, when the computer system 110 is implemented to analyze knowledge graphs of a computer network, entities may include different devices and their relations may include the nature of their communication links. In a recommendation engine context, entities may include movie or other entertainment works and individuals such as actors or directors and their relations may include relationships such as entity movie is “directed by” a specific director or “is acted by” a specific actor. In the context of finance such as in the example above, entities may include a merchant and a cardholder and their relations may include types of transactions between them such as purchase transactions, refund transactions, and other types of transactions.

In these and other contexts, a knowledge graph 101 may provide insights on relationships between entities, which may be used for training neural networks to perform various machine learning tasks, such as link prediction that predicts whether a given two entities have a relationship with one another, classification such as to recommend similar movies or other works, and/or other tasks. In a particular implementation, link prediction may be used to determine whether a merchant and a cardholder are linked for transaction validation or fraud detection.

### Partition Generation

Partitioning knowledge graphs 101 to parallelize or otherwise separately analyse portions of the knowledge graphs 101 may improve the speed in which embeddings are learned and overall system performance. However, improper partitioning may disrupt the structure of a knowledge graph 101 and result in loss of the ability to draw inferences from the data, degrading the effectiveness of learning from the data to train neural networks to complete downstream tasks. The knowledge graph partitioning subsystem 120 may conduct improved partitioning to generate a plurality of partitions or subgraphs from the knowledge graph 101 in a way that maintains the structure for generating embeddings to train neural networks to perform downstream tasks. Each partition may include a respective subset of nodes from the knowledge graph 101 that are related to one another. Because nodes represent entities, the terms “node” and “entity” may be used interchangeably herein throughout. Furthermore, because edges represent relations, the terms “edge” and “relation” may be used interchangeably herein throughout.

To partition the knowledge graph 101, the knowledge graph partitioning subsystem 120 may generate an adjacency matrix based on node relationships. An adjacency matrix is a square matrix that represents edges between nodes in the knowledge graph 101. The adjacency matrix, A, may be defined by the number of nodes N and relations Rn. The adjacency matrix, A, may be formed by identifying a link Rn between two nodes and adding 1 to the position A(x,y) and A(y,x) corresponding to the two nodes. This process is repeated for each type of relation for all nodes. Thus, a weighted adjacency matrix is formed through this process based on the edges (links) between nodes.

The knowledge graph partitioning subsystem 120 may then partition the knowledge graph 101 based on the adjacency matrix. For example, the knowledge graph partitioning subsystem 120 may execute a partitioning algorithm that uses the adjacency matrix and community detection to generate an initial set of partitions. This initial set of partitions may be generated based on modularity score maximization, which maximizes the modularity of generated partitions. A modularity score is a metric for assessing the modularity of distinct communities of nodes. Modularity is a level of closeness or relatedness of the nodes in a community. A community is a grouping of nodes, and will be a partition when the partitioning algorithm has partitioned the knowledge graph 101. The modularity score for each partition may be determined based on Equation (1):

$${M}_{c} = \frac{αin}{2 e} - {( \frac{αall}{2 e} )}^{2} , \qquad ( 1 )$$

in which:
M_{c} is the modularity score for a given partition c (also referred to as a “community” of nodes);
αᵢₙ represents the total weight of all links between nodes contained within partition c;
αₐₗₗ represents the total weight of all links for nodes contained in partition c; and
e is the total weight of all links in the graph.

Modularity score maximization may involve initializing each node as its own community and then determining a modularity score M_{c} for a neighboring community if the node is moved to that community. This process may be performed for each node until no significant modularity score gains are observed beyond a threshold value. The resulting communities become the initial set of partitions. One example of a partitioning algorithm that may perform modularity score maximization is the Lovain Clustering (LC) algorithm. In particular, Lovain Constellation Partitioning (LCP) uses the LC algorithm to partition a knowledge graph 101 based on graph topology.

After the initial set of partitions is obtained, the knowledge graph partitioning subsystem 120 may remove, from this initial set, partitions that have a number of nodes below a threshold H₁. The threshold H₁ is used to remove outliers that are likely noise in the knowledge graph 101, which can distort the embedding process. The threshold H₁ may be a hyperparameter that can be configured and may be specific to a given knowledge graph 101.

After the noisy entities are removed, the knowledge graph partitioning subsystem 120 may perform one or more levels of hierarchical merging operations that merges at least some of the remaining partitions to obtain C number of partitions for downstream training. Initially, the partitioning algorithm (such as LC) may generate a large number of partitions due to its limitation in partitioning heterogeneous directed graphs. As a result of this limitation, many partitions are formed that contain a small number of entities that is still higher than H₁ but lower than what may be useful for embeddings. Therefore, the knowledge graph partitioning subsystem 120 may merge these partitions with larger and more dense partitions to avoid losing the structural information contained within a given knowledge graph 101. To do so, the knowledge graph partitioning subsystem 120 may use incremental thresholding over one or more levels of merging to assess the partitions.

In one level of merging for incremental thresholding, the knowledge graph partitioning subsystem 120 may use a Nearest Linked Neighbor (NLN) approach. In NLN, if the number of entities contained within a partition Kₐ is below a threshold, Φ, the partition Kₐ will be merged with another partition having a higher number of entities than Kₐ and having the most number of links from among the remaining partitions.

In other levels of merging for incremental thresholding, the knowledge graph partitioning subsystem 120 may apply one or more hard thresholds to the partitions to maintain a steady growth of entity numbers for highly dense partitions. The purpose of these thresholds is to moderate the number of entities in each partition and to avoid entity explosion. For partitions containing a higher number of entities, smaller partitions that are designated as NLN will be merged iteratively with them. As a result of this method, a similar number of entities is obtained for each partition while the overall modularity of the graph remains high.

Table 1 shows an example of an algorithm in pseudocode for Louvain Constellation Partitioning. The pseudocode is provided for illustration and not limitation, as various functions or features may be added, omitted, or modified consistent with the disclosures above.

Lovain Constellation Partitioning

| | |
|---|---|
| 1 | Initialize: A, A′ as square matrices of zeroes with each dimension |
| | equal to the number of nodes, N |
| 2 | Initialize γ, β, δ, σ |
| 3 | For i = 1 : length (T) |
| 4 | Add 1 to positions in A_{(T(1,0), T(1,2))} |
| 5 | Add 1 to positions in A_{(T(1,2), T(1,0))} |
| 6 | A′_{(T(1,0), 7(1,2))} = 1 |
| 7 | A′_{(T(1,2), T(1,0))} = 1 |
| 8 | End |
| 9 | Apply Lovain clustering to A |
| 10 | Maximize modularity based on Equation (1) |
| 11 | Cluster and eliminate entities with threshold H₁ |
| 12 | Obtain k no. of labels for entities and store in vector L |
| 13 | Create a list U with all entities present in each partition |
| 14 | For j = 1 : 3 |
| 15 | For m = 1 : N |
| 16 | B = A′₍ₘ₎ * L |
| 17 | Store the label at position A′_{(m,m)} as l |
| 18 | For p = 1: k |
| 19 | c = Number of entities in B with label p |
| 20 | Store c in vector C at position C₍ₚ₎ |
| 21 | End |
| 22 | Find argmax(C), G whose label is not l |
| 23 | Store the label, p for G and this is the partition that is |
| | adjacent to node m |
| 24 | Store p in vector M at position Mₘ |
| 25 | End |
| 26 | For q = 1: k |
| 27 | Identify positions in vector L with label k |
| 28 | Take the corresponding positions from vector M and stored |
| | them in vector D |
| 29 | Based on majority voting of nodes in vector D, select the |
| | nearest cluster, s |
| 30 | Φ= γ * β * δ |
| 31 | If length(U(s)) < σ and length(U(k)) < Φ |
| 32 | Merge the two clusters by applying labels from the |
| | bigger cluster to the smaller one |
| 33 | End |
| 34 | End |
| 35 | γ = 2 * γ |
| 36 | End |

### Weighted Aggregation Composition Convolution

The compositional message passing subsystem 130 may use Weighted Aggregation Composition (WAC) with convolution and in some instances with attention. WAC uses message aggregation in which messages are collected, weighted and aggregated from neighbouring nodes to update a given node's representation. The messages may include data about the neighboring nodes, such as a vector representation or other data about the neighboring nodes. WAC also involves composition of the data aggregated from other nodes. During composition, the compositional message passing subsystem 130 may combine the transformed aggregated features from the convolution step with the original features of the node itself.

In this way, the given node will learn from its neighbour nodes in each partition. In some implementations, single layer aggregation is used in which a single weighted sum or other function is used for each node. In other implementations, multi-level aggregation is used in which both inner layers and outer layers are used. Inner layers may involve message aggregation from immediately surrounding nodes while outer layers may involve message aggregation across larger neighborhoods, incorporating broader contextual data in the partition. In some instance, recursive aggregation may be performed in which multiple aggregation rounds are executed using previous round outputs as inputs.

During message aggregation, the compositional message passing subsystem 130 may use graph attention layers to train embeddings of entities and relations by passing through two composition functions for message aggregation. These two composition functions are respectively based on Equations (2) and (3):

$${h}_{u} = {e}_{u}^{g} * {w}_{u}^{e} * {r}_{u} , \qquad ( 2 )$$

$${h}_{v} = {\sum }_{b = 1}^{z} {\sum }_{v = 1}^{f} ( {e}_{v}^{g} * {w}_{u}^{e} * {r}_{b}^{g} + {e}_{v}^{g} * {w}_{b}^{r} ) \qquad ( 3 )$$

In which:
hᵤ and hᵥ represent the composition operations to transform a particular entity, once updating itself using its entity weight and self-loop and a second time by the weights and messages from its neighbors.;
e and r are the head entity and relation, respectively;
w^{e} and w^{r} denote the learnable weight matrices needed to transform the entities and relationships, respectively;
g represents the current state of embeddings;
u represents the entity number;
v represents the neighbor number of the entity u;
b represents the relation type number out of z number of relations which connects u to its neighbors v; and
f represents the total number of neighbors that entity u is connected to.

Once hᵥ and hᵤ are determined, the compositional message passing subsystem 130 may use an activation function for each level of message aggregation. The activation function may include the Gaussian error linear unit (Gelu) activation function to update the message-passing function. Next, the summation of neighborhood messages represented by hᵤ is passed through an attention layer after normalizing the messages with the degree matrix G. The attention layer, Γ, adds specific attention to all features for each entity. Finally, the compositional message passing subsystem 130 may determine a weighted sum of hv and hu, which puts more weight on self-loops. The process may be summarized based on Equation (4):

$${e}_{u}^{g + 1} = {W}_{1} * α ( {h}_{u} ) + {W}_{2} + α ( Γ ( {G}^{- 0.5} * {h}_{v} * {G}^{- 05} ) ) , \qquad ( 4 )$$

In which:
g+1 represents the next stage of the entity embeddings; and
W1 and W2 are scalar weights and are separate for each level of aggregation.

The compositional message passing subsystem 130 may update the relation embeddings based on Equation (5):

$${r}_{b}^{g + 1} = {r}_{b}^{g} * {w}_{b}^{ς} , \qquad ( 5 )$$

In which:
wζ represents a separate learnable weight matrix from wr and can be updated using backpropagation to emphasize more dominant relations in the KG.

A new 1D convolutional neural network (1D-CNN) is used to decode the embedding that uses a multiplication operation of entities and relation embeddings. This module consists of several filters and a dense layer that is trained iteratively to produce meaningful features from obtained embeddings. Batch normalization is utilized two times, one after the convolutional process and the second time after passing through the dense layer. The binary cross entropy (BCE) loss function is used to train each partition of entities and relationships separately and so the algorithm ends up with C-1 number of embedding vectors for each entity and each relation.

### Global Decoder Framework and Inference

Once the embeddings for entities and relations are obtained, the global decoder subsystem 140 may concatenate the embeddings from different encoders to obtain features at a global level. The global decoder subsystem 140 may use a neural network such as a two-layer multilayer perceptron (MLP), which is trained on the training data. The entire training data is fed to this network a second time to train the weights of the MLP. The initial encoders are therefore discarded and the obtained embeddings for each node and relation are used that already contain local messages from their neighbors. The feature vectors for all nodes and relations are therefore concatenated and for C number of partitions the dimensionality of the embedding space is increased by C-1 times. These features are then fed into the MLP after multiplying the embeddings with trainable weight matrices. Two distinct weight matrices We and Wr are initialized, with We having a dimensionality of N by 2E and Wr having a dimensionality of 2R by 2E, where N is the number of nodes, R is the number of relations in the graph and E is the embedding dimension for the nodes and relations. These weights are then trained along with the weights for the MLP in an end-to-end fashion utilizing a multiclass binary cross-entropy loss. The final model and the embeddings of nodes and relations are then used for inference. For the test data, the nodes and relations provided in the test set are taken and fed to the model to predict the tail. Similarly, the reverse is done for predicting the head.

The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. Each of these multiple processors or cores may, alone or in combination with other processors or cores, perform some or all the functionality described herein with respect to the processor 112. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

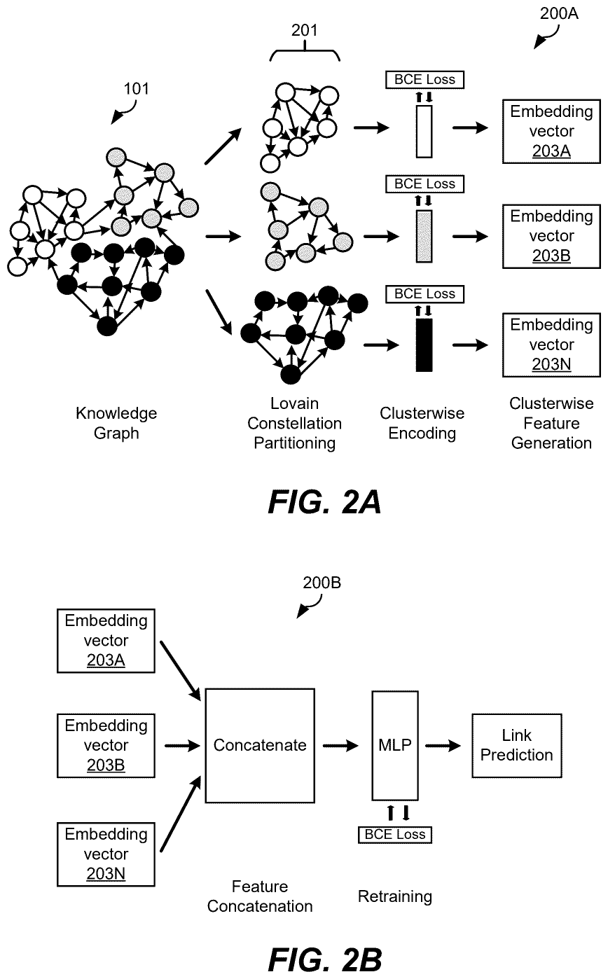

FIG. 2A illustrates a schematic example 200A of partitioning a knowledge graph 101 and performing partition-wise encoding to generate partition-specific embeddings for training a neural network. For example, the knowledge graph 101 may be partitioned into a plurality of partitions 201 (illustrated as partitions 201A-N) based on a partitioning algorithm such as LCP. The partitioning algorithm divides the training triples for different partitions when training from each of the partitions, such as independently from other partitions. In particular, embeddings for the different partitions 201 may be learned in parallel, reducing the amount of time used for training. A binary cross entropy (BCE) loss function is used to train each partition of entities and relationships separately and so the algorithm ends up with C-1 number of embedding vectors 203 (also referred to simply as “embeddings”) for each entity and each relation.

FIG. 2B illustrates a schematic example 200B of concatenating the partition-specific embeddings for training and retraining neural networks to perform link prediction. As illustrated, node and relation features are concatenated along with retraining a neural network (such as an MLP) for link prediction. Two distinct weight matrices. These weights are then trained along with the weights for the MLP in an end-to-end fashion utilizing a multiclass binary cross-entropy (BCE) loss. The final model and the embeddings of nodes and relations are then used for inference.

In the description of the figures that follow, reference may be made to elements appearing in FIGS. 1 and 2 for illustration.

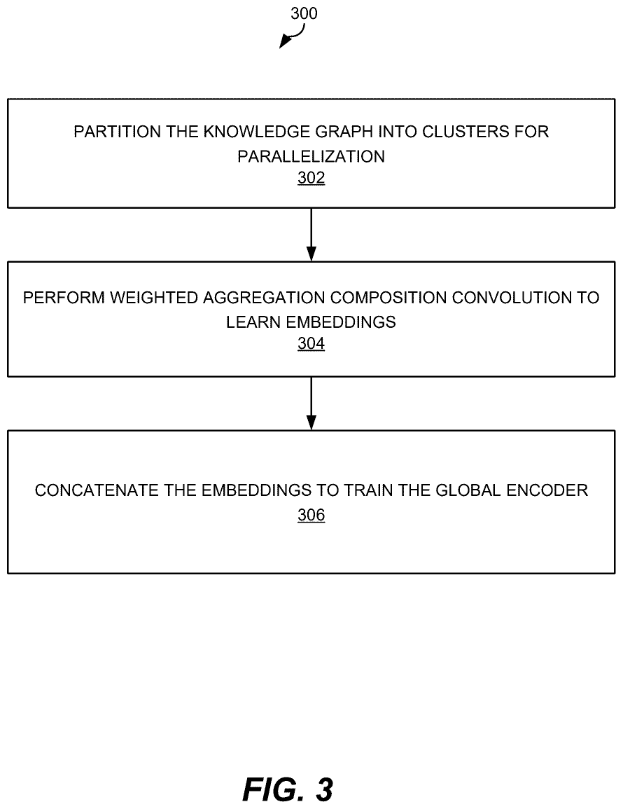

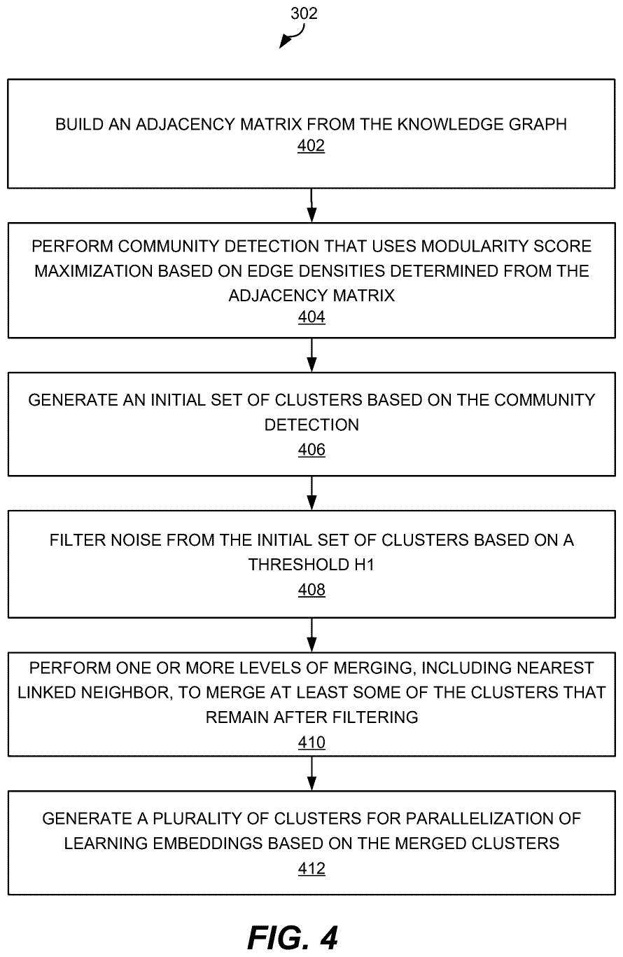

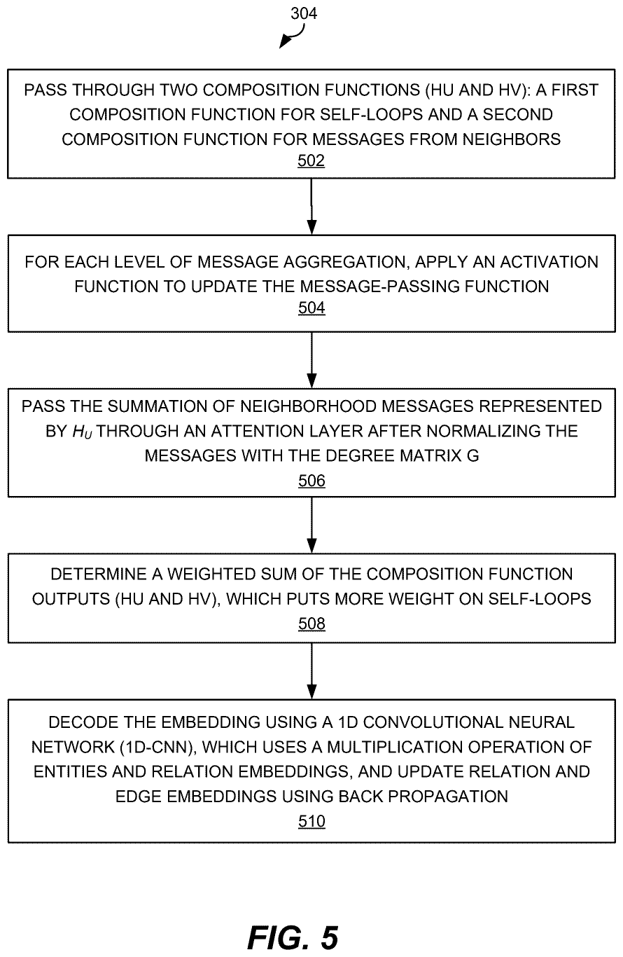

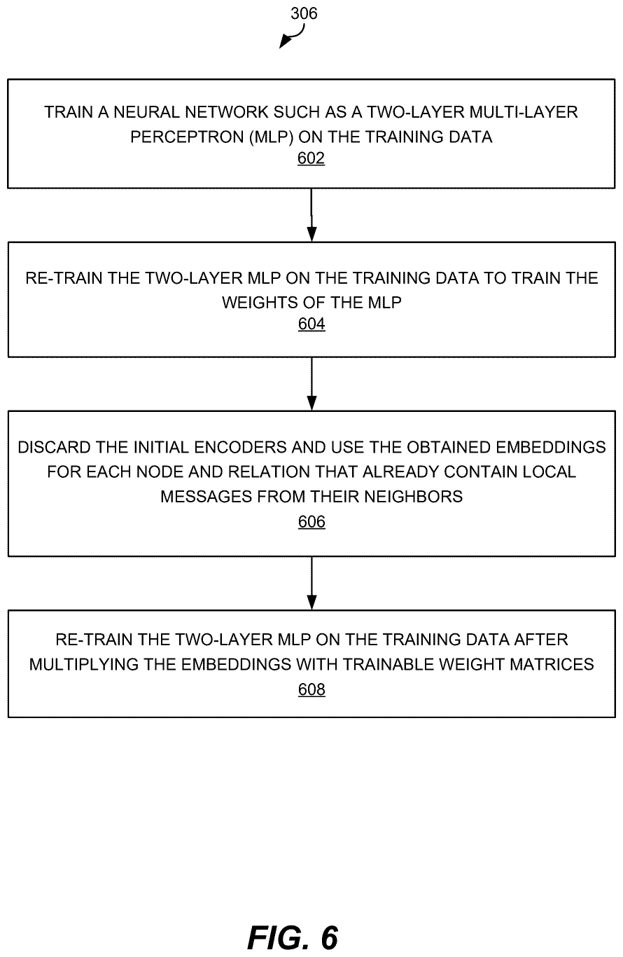

FIG. 3 illustrates an example of a method 300 for partitioning-based scalable weighted aggregation composition for embeddings learned from knowledge graphs 101 for training neural networks to perform link prediction or other downstream tasks. At 302, the method 300 may include partitioning the knowledge graph 101 into partitions 201 for parallelization. Each of the partitions 201 may be individually used to learn embeddings in parallel, improving the speed at which the learning occurs. Partitioning knowledge graphs must be performed in a way that does not disrupt the structure of the knowledge graph 101. Examples of such partitioning are described with respect to the knowledge graph partitioning subsystem 120 and also with respect to FIG. 4. At 304, the method 300 may include performing weighted aggregation composition convolution to learn embeddings. Examples of such embedding learning are described with respect to the compositional message passing subsystem 130 and also with respect to FIG. 5. At 306, the method 300 may include concatenating the embeddings from each partition to train the global encoder. Examples of such concatenating are described with respect to the global decoder subsystem 140 and also with respect to FIG. 6.

FIG. 4 illustrates an example of a method 302 for partitioning a knowledge graph 101. At 402, the method 302 may include building an adjacency matrix from the knowledge graph 101. At 404, the method 302 may include performing community detection that uses modularity score maximization based on edge densities determined from the adjacency matrix.

At 406, the method 302 may include generating an initial set of partitions based on the community detection. At 408, the method 302 may include filtering noise from the initial set of partitions based on a threshold H1, which may be a hyperparameter input. For example, the method 302 may include removing partitions that have a number of nodes below the threshold H1. At 410, the method 302 may include performing one or more levels of merging, including using NLN to merge at least some of the partitions that remain after filtering. At 412, the method 302 may include generating the plurality of partitions for parallelization of learning embeddings based on the merged partitions.

FIG. 5 illustrates an example of a method 304 of performing weighted average composition convolution to learn embeddings. An embedding may be learned from each of the plurality of partitions. Embeddings may be learned based on aggregation of messages from neighboring nodes and adjusting the node based on the aggregated messages.

At 502, the method 304 may include passing through two composition functions in which a first composition function for self-loops and a second composition function for messages from neighbors. At 504, the method 304 may include, for each level of message aggregation, applying an activation function to update the message-passing function that facilitates learning from neighboring nodes. At 506, the method 304 may include passing the summation of neighborhood messages represented by hᵤ through an attention layer after normalizing the messages with the degree matrix G.

At 508, the method 304 may include determining a weighted sum of the composition function outputs (hᵤ and hv), which puts more weight on self-loops. At 510, the method 304 may include decoding the embedding using a 1D convolutional neural network (1D-CNN), which uses a multiplication operation of entities and relation embeddings, and updating relation and edge embeddings using back propagation.

FIG. 6 illustrates an example of a method 306 of concatenating the embeddings learned from each partition. At 602, the method 306 may include training a neural network, such as a two-layer MLP, on training data. At 604, the method 306 may include re-training the MLP (a second time after 602) using the training data to train the weights of the MLP. At 606, the method 306 may include discarding the initial encoders and use the obtained embeddings for each node and relation that already contain local messages from their neighbors. At 608, the method 306 may include re-training the two-layer MLP on the training data after multiplying the embeddings with trainable weight matrices.

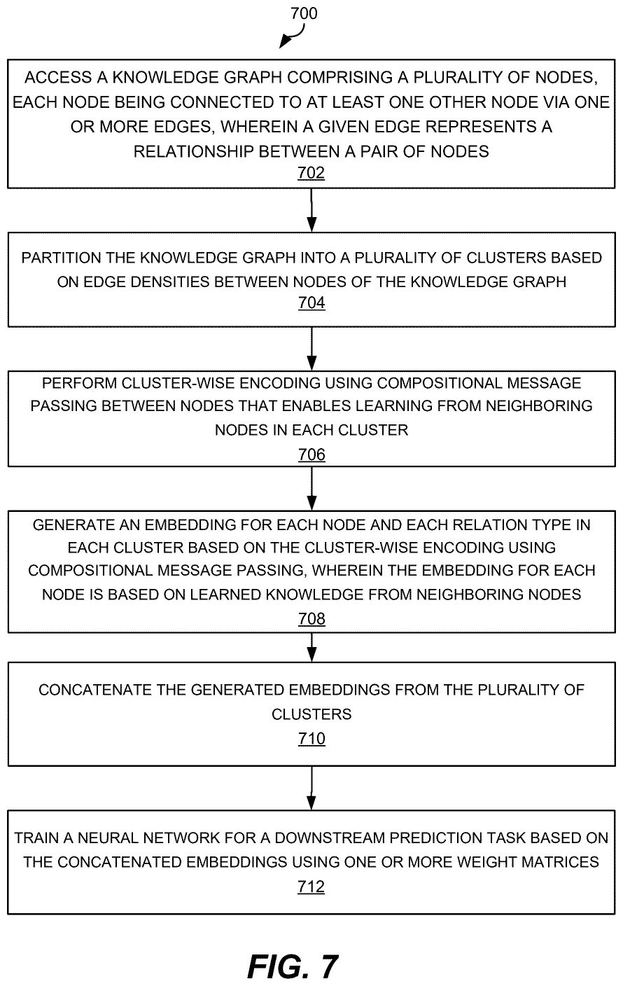

FIG. 7 illustrates an example of a method 700 for generating knowledge graph embeddings using partitioning-based scalable weighted aggregation composition. At 702, the method 700 may include accessing a knowledge graph 101 comprising a plurality of nodes, each node being connected to at least one other node via one or more edges, wherein a given edge represents a relationship between a pair of nodes. In some instances, the knowledge graph 101 may be converted into a homogeneous graph. At 704, the method 700 may include partitioning the knowledge graph 101 into a plurality of partitions 201 based on edge densities between nodes of the knowledge graph. At 706, the method 700 may include performing partition-wise encoding using compositional message passing between nodes that enables learning from neighboring nodes in each partition. At 708, the method 700 may include generating an embedding for each node and each relation type in each partition based on the partition-wise encoding using compositional message passing, wherein the embedding for each node is based on learned knowledge from neighboring nodes. At 710, the method 700 may include concatenating the generated embeddings from the plurality of partitions. At 712, the method 700 may include training a neural network for a downstream prediction task based on the concatenated embeddings using one or more weight matrices.

The foregoing techniques were tested using open source training data, as listed in Table 2 below. E represents the number of entities or nodes in the graph and R represents the total number of relations in the graphs. Training, Valid and Test represent the unique number of triplets (head, relation, tail) in each of the groups of data.

TABLE 2

| Dataset | E | R | Training | Valid | Test |
|---|---|---|---|---|---|
| FB15K | 14,951 | 1,345 | 483,142 | 50,000 | 59,071 |
| FB15K-237 | 14,541 | 237 | 272,115 | 17,424 | 20,466 |
| WN18 | 40,943 | 18 | 141,442 | 5,000 | 5,000 |
| WN18RR | 40,943 | 11 | 86,835 | 3,034 | 3,134 |

Table 3 below shows the results from partitioning different knowledge graphs using the disclosed Lovain Constellation method.

| | | Number of Partitions (C) | | | | | | |
|---|---|---|---|---|---|---|---|---|
| Dataset | Split | 2 | 3 | 4 | 5 | 6 | 7 | 8 |
| FB15k-237 | Train | 99.98% | 85.28% | 79.50% | — | 73.30% | 73.09% | 72.50% |
| | Valid | 99.82% | 81.25% | 72.72% | — | 65.15% | 64.86% | 64.06% |
| | Test | 99.91% | 81.79% | 73.08% | — | 65.59% | 65.49% | 64.45% |
| FB15k | Train | 99.89% | 89.44% | 87.87% | 75.12% | 74.14% | 73.99% | 73.54% |
| | Valid | 99.88% | 89.23% | 87.63% | 74.34% | 73.4% | 73.26% | 72.52% |
| | Test | 99.86% | 89.24% | 87.56% | 74.15% | 73.11% | 72.98% | 72.78% |
| WN18RR | Train | 100% | 93.97% | 94.38% | — | 92.17% | — | 90.71% |
| | Valid | 92.76% | 79.64% | 81.49% | — | 76.00% | — | 73.20% |
| | Test | 92.56% | 80.32% | 80.52% | — | 77.19% | — | 73.60% |
| WN18 | Train | 100% | 94.43% | 92.79% | 91.22% | — | 90.79% | 90.11% |
| | Valid | 100% | 88.46% | 85.46% | 81.82% | — | 81.16% | 79.40% |
| | Test | 100% | 89.62% | 86.24% | 83.34% | — | 83.08% | 81.12% |

Referring to Table 3, only the training sets are used to create partitions. However, using the disclosed entity partitioning algorithm, results are evaluated on the test and valid sets for each knowledge graph (KG). It is seen that in all cases over 70% of the training triples have their head and tail within the same partition even at 8 separate partitions. For the test and validation sets, except for dataset FB15k-237, all datasets show a high THP over 70%. While THP is inversely proportional to the number of partitions generated using the proposed method, for dense KG such as FB15k and WN18 it is evident that the proposed LCP can retain much of the original structure of the KG even if the KG is broken down into several disjoint partitions.

Table 4 illustrates a comparison of the disclosed embedding method to other methods, where O/M represents out-of-memory for a certain set of hyperparameters.

| | | Comp- | | | |
|---|---|---|---|---|---|
| Dataset | Method | GCN | RAGAT | SE-GNN | WAC |
| FB15k-237 | MRR (400) | 0.338 | 0.349 | 0.364 | 0.341 |
| | MRR (1500) | 0.350 | 0.355 | N/A | 0.351 |
| | T/epoch (s) | 57.92 | 65.20 | 113.33 | 24.98 |
| FB15k | MRR (400) | 0.600 | 0.598 | O/M | 0.723 |
| | MRR (1500) | 0.621 | 0.637 | O/M | 0.742 |
| | T/epoch (s) | 95.98 | 168.23 | N/A | 65.16 |
| WN18RR | MRR (400) | 0.452 | 0.472 | 0.482 | 0.468 |
| | MRR (1500) | 0.464 | 0.478 | N/A | 0.481 |
| | T/epoch (s) | 47.20 | 70.76 | 98.26 | 42.390 |
| WN18 | MRR (400) | 03937 | 0.941 | 0.940 | 0.947 |
| | MRR (1500) | 0.940 | 0.944 | 0.942 | 0.952 |
| | T/epoch (s) | 50.41 | 62.60 | 105.86 | 42.78 |

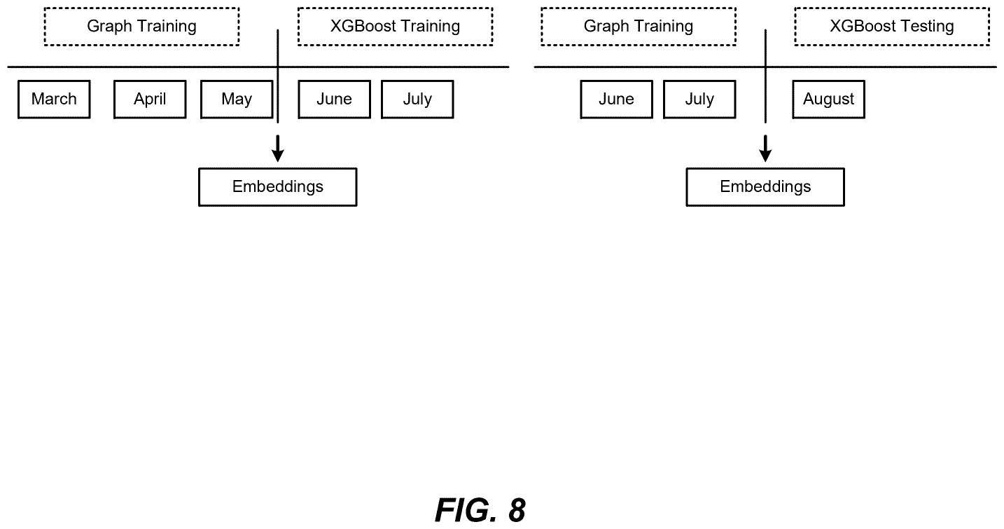

FIG. 8 illustrates a schematic diagram 800 of an example of a training and testing pipeline for assessing the performance of baseline modeling and the partition-based scalable WAC convolution and merging described herein. Knowledge graphs are the more generalized versions of graphs and carry much more information than normal graphs. In the case of payment card transaction data, transaction graphs there may exist multiple edges between nodes in which each node can denote different types of transaction. Normal graphs will consider all of these types transactions as equivalent to one another. However, knowledge graphs consider each different type of transaction as a different type of relation, thereby generating more informative embeddings. This can directly help in increasing performance in various downstream tasks such as first party fraud, dispute predictions, and/or other machine learning tasks. Furthermore, knowledge graphs may also be used to train neural networks to predict future transactions by predicting relations using the node completion task of knowledge graphs.

The modeling techniques in this example used transaction data involving merchants and cardholders. The data included 69 velocity features and 23 transaction level features such as whether the transaction is domestic, transaction category, and others. Bipartite graphs based on this data include edges that denote a transaction between respective cardholder and merchant. Knowledge graphs based on this data include edges that denote relation between cardholders and merchants using transaction level features.

Embeddings are generated for each cardholder using various graph algorithms. These embeddings along with velocities can be used for any downstream task. XGBoost is fed with both velocities and embeddings to predict the fraud based on the transaction data. Embeddings extracted from graph captures the fraudulent behavior of cardholder.
Method 1 (using only velocities): Only the velocities and XGBoost are used for fraud detection like most of the cases.
Method 2 (using velocities+Graph Embeddings): Embeddings extracted from Graph Convolution Network (GCN) model is attached with the velocities and fed to XGBoost.
GCN is trained on the historic data for all card and merchant in the XGBoost training data
Method 3 (using velocities+Knowledge Graph Embeddings): Embeddings extracted from CompGCN model are attached with the velocities and fed to XGBoost. GCN is trained on the historic data for all card and merchant in the XGBoost training data.
Method 4 (using velocities+Proposed Knowledge Graph embeddings as described herein). Embeddings are based on the KG algorithm (WAC) along with Louvain constellation partitioning and are then attached with the velocities and fed to XGBoost. GCN is trained on the historic data for all card and merchant in the XGBoost training data.

Table 4 illustrates performance comparison between Methods 1-4. Methods that include embeddings along with velocities improve performance (compare results of method 1 versus methods 2-4). Furthermore, method 3 illustrates that knowledge graph embeddings are more useful than normal graph embeddings. Finally, method 4 using techniques disclosed herein also achieves performance higher than method 2, but the time taken for training each epoch is almost 1.5 times less than method 3.

| | | | | Duration |
|---|---|---|---|---|
| | | | | of Graph |
| | | Embedding | Average | Training |
| | | Method | Precision | for 1000 |
| Method 1 | Velocity | — | 0.554 | — |
| | Variables | | | |
| Method 2 | Velocity | +Graph Embeddings | 0.756 | 410 |
| | Variables | (GCN) | | |
| Method 3 | Velocity | +Knowledge Graph | 0.856 | 590 |
| | Variables | Embeddings | | |
| | | (CompGCN) | | |
| Method 4 | Velocity | +Knowledge Graph | 0.851 | 435 |
| (as described | Variables | Embeddings (WAC) | | |
| herein) | | | | |

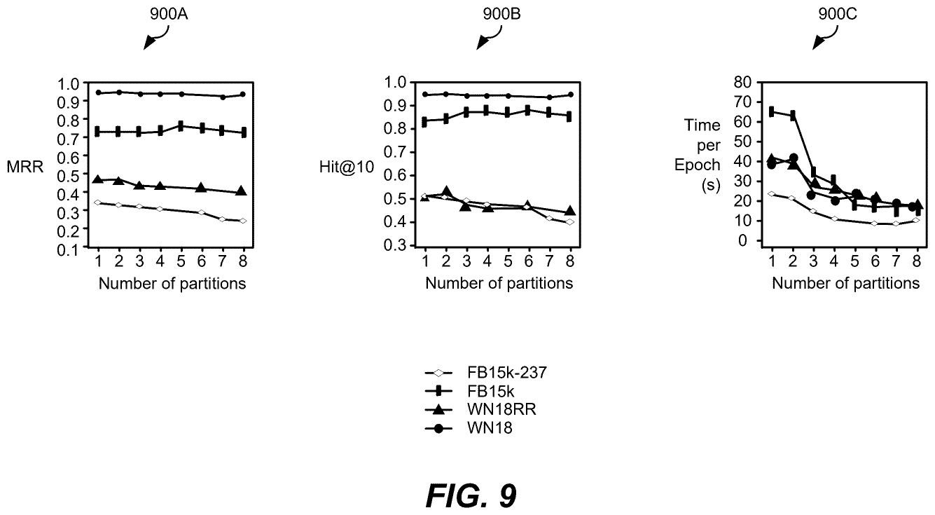

FIG. 9 illustrates plots 900A-C of performance of various datasets with different numbers of partitions produced using LPC and global merging. The training time decreases significantly with the increase in the number of partitions while the MRR and Hit@10 steadily fall. The legend provided at plot 900C applies for all plots and the symbols used to distinguish each plot line is used only to distinguish the plot lines from one another.

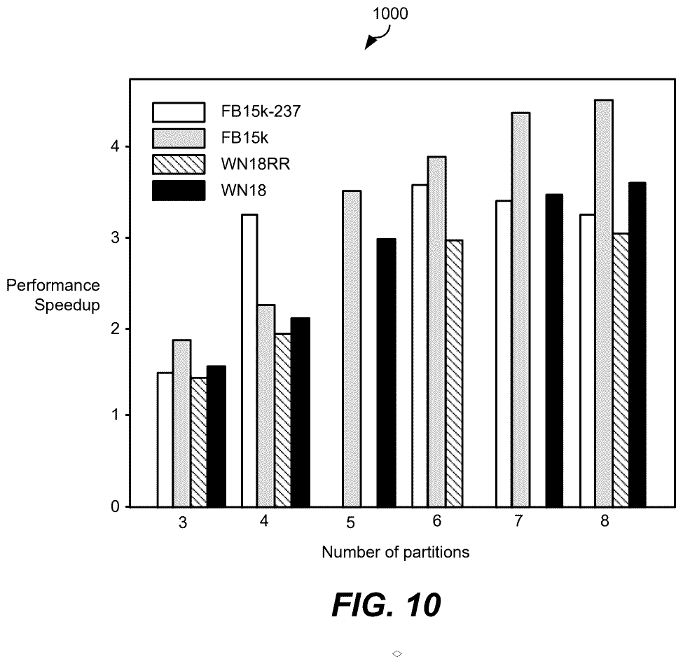

FIG. 10 illustrates a plot of number of partitions versus performance improvement (speedup) in a speedup evaluation of LPC and WAC with parallelization. Compared to the training time of the base model, WAC, utilizing LPC with parallel training speeds up the training process significantly.

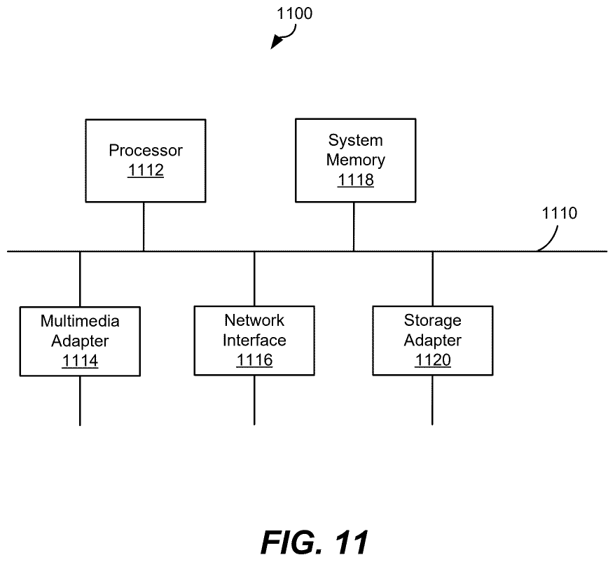

FIG. 11 illustrates an example of a computer system 1100 that may be implemented by devices illustrated in FIG. 1. The computer system 1100 may be part of or include the system environment 100 to perform the functions and features described herein. For example, various ones of the devices of system environment 100 may be implemented based on some or all of the computer system 1100. The computer system 1100 may include, among other things, an interconnect 1110, a processor 1112, a multimedia adapter 1114, a network interface 1116, a system memory 1118, and a storage adapter 1120.

The interconnect 1110 may interconnect various subsystems, elements, and/or components of the computer system 1100. As shown, the interconnect 1110 may be an abstraction that may represent any one or more separate physical buses, point-to-point connections, or both, connected by appropriate bridges, adapters, or controllers. In some examples, the interconnect 1110 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 1110 may allow data communication between the processor 1112 and system memory 1118, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 1112 may control operations of the computer system 1100. In some examples, the processor 1112 may do so by executing instructions such as software or firmware stored in system memory 1118 or other data via the storage adapter 1120. In some examples, the processor 1112 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 1114 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 1116 may provide the computer system 1100 with an ability to communicate with a variety of remote devices over a network. The network interface 1116 may include, for example, an Ethernet adapter, a Fibre Channel adapter, and/or other wired- or wireless-enabled adapter. The network interface 1116 may provide a direct or indirect connection from one network element to another, and facilitate communication and between various network elements.

The storage adapter 1120 may connect to a standard computer readable medium for storage and/or retrieval of information, such as a fixed disk drive (internal or external).

Other devices, components, elements, or subsystems (not illustrated) may be connected in a similar manner to the interconnect 1110 or via a network. The devices and subsystems can be interconnected in different ways from that shown in FIG. 8. Instructions to implement various examples and implementations described herein may be stored in computer-readable storage media such as one or more of system memory 1118 or other storage. Instructions to implement the present disclosure may also be received via one or more interfaces and stored in memory. The operating system provided on computer system 1100 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The databases (such as training database 111 and/or model database 113) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
access a knowledge graph comprising a plurality of nodes, each node being connected to at least one other node via one or more edges, wherein a given edge represents a relationship between a pair of nodes;
partition the knowledge graph into a plurality of partitions based on edge densities between nodes of the knowledge graph;
perform partition-wise encoding using compositional message passing between nodes that enables learning from neighboring nodes in each partition;
generate an embedding for each node and each relation type in each partition based on the partition-wise encoding using compositional message passing, wherein the embedding for each node is based on learned knowledge from neighboring nodes;
concatenate the generated embeddings from the plurality of partitions; and
train a neural network for a downstream prediction task based on the concatenated embeddings using one or more weight matrices.

2. The system of claim 1, wherein to partition the knowledge graph, the processor is programmed to:
identify, for each type of relationship between nodes, links between the nodes;
generate a weighted adjacency matrix based on the identified links; and
generate an initial set of partitions based on modularity score maximization that selects partitions based on respective modularity scores, wherein a modularity score indicates a number of edges between nodes of a candidate partition, wherein the plurality of partitions is based on the initial set of partitions.

3. The system of claim 2, wherein the processor is further programmed to:
for each partition in the initial set of partitions:
identify a number of nodes in the partition;
compare the number of nodes to a threshold number of nodes; and
filter in or out the partition to retain or remove the partition based on the comparison;
generate a filtered set of partitions based on the filter applied to each partition, wherein the plurality of partitions is based on the filtered set of partitions.

4. The system of claim 3, wherein the processor is further programmed to:
for each partition in the filtered set of partitions:
compare the number of nodes in the partition with a second threshold number of nodes; and
determine, based on the comparison using the second threshold number, whether or not to merge the partition with another partition with more dense edges based on a nearest linked neighbor analysis.

5. The system of claim 1, wherein to generate the embedding for each node, the processor is further programmed to:
execute a message passing function having two level message passing;
generate, as an output of the message passing function, a first message composition and a second message composition; and
update the message passing function using an activation function on the first message composition and the second message composition.

6. The system of claim 5, wherein to execute the message passing function, the processor is further programmed to:
execute a first composition function that uses a first set of learnable weight matrices; and
execute a second composition function that uses a second set of learnable weight matrices.

7. The system of claim 6, wherein the first message composition represents messages from neighbor nodes, and wherein the processor is further programmed to:
apply an attention mechanism based on the first message composition to adjust the first set of learnable weight matrices.

8. The system of claim 5, wherein the processor is further programmed to:
decode each embedding based on a one-dimensional convolutional neural network.

9. The system of claim 1, wherein the neural network comprises a multilayer perceptron, and wherein to train the neural network, the processor is further programmed to:
initialize a first set of weight matrices based on a number of nodes and a second set of weight matrices based on a number of edges;
retrain the multilayer perceptron based on a training dataset used for the knowledge graph to update the first set of weight matrices and the second set of weight matrices.

10. The system of claim 1, wherein the downstream prediction task comprises link prediction that generates a prediction of whether or not at least two nodes each representing entities are linked to one another in a computationally efficient way.

11. The system of claim 10, wherein the entities comprise a merchant and a cardholder.

12. A method, comprising:
accessing a knowledge graph comprising a plurality of nodes, each node being connected to at least one other node via one or more edges, wherein a given edge represents a relationship between a pair of nodes;
partitioning the knowledge graph into a plurality of partitions based on edge densities between nodes of the knowledge graph;
performing partition-wise encoding using compositional message passing between nodes that enables learning from neighboring nodes in each partition;
generating an embedding for each node and each relation type in each partition based on the partition-wise encoding using compositional message passing, wherein the embedding for each node is based on learned knowledge from neighboring nodes;
concatenating the generated embeddings from the plurality of partitions; and
training a global neural network for a downstream prediction task based on the concatenated embeddings using one or more weight matrices.

13. The method of claim 12, wherein partitioning the knowledge graph comprises:
identifying, for each type of relationship between nodes, links between the nodes;
generating a weighted adjacency matrix based on the identified links; and
generating an initial set of partitions based on modularity score maximization that selects partitions based on respective modularity scores, wherein a modularity score indicates a number of edges between nodes of a candidate partition, wherein the plurality of partitions is based on the initial set of partitions.

14. The method of claim 13, further comprising:
for each partition in the initial set of partitions:
identifying a number of nodes in the partition;
comparing the number of nodes to a threshold number of nodes; and
filtering in or out the partition to retain or remove the partition based on the comparison;
generating a filtered set of partitions based on the filter applied to each partition, wherein the plurality of partitions is based on the filtered set of partitions.

15. The method of claim 14, further comprising:
for each partition in the filtered set of partitions:
comparing the number of nodes in the partition with a second threshold number of nodes; and
determining, based on the comparison using the second threshold number, whether or not to merge the partition with another partition with more dense edges based on a nearest linked neighbor analysis.

16. The method of claim 12, wherein generating the embedding for each node comprises:
executing a message passing function having two level message passing;
generating, as an output of the message passing function, a first message composition and a second message composition; and
updating the message passing function using an activation function on the first message composition and the second message composition.

17. The method of claim 16, wherein executing the message passing function comprises:
executing a first composition function that uses a first set of learnable weight matrices; and
executing a second composition function that uses a second set of learnable weight matrices.

18. The method of claim 17, wherein the first message composition represents messages from neighbor nodes, and wherein the method further comprises:
applying an attention mechanism based on the first message composition to adjust the first set of learnable weight matrices.

19. A non-transitory computer readable medium storing instructions that, when executed by a processor, programs the processor to:
access a knowledge graph comprising a plurality of nodes, each node being connected to at least one other node via one or more edges, wherein a given edge represents a relationship between a pair of nodes;
partition the knowledge graph into a plurality of partitions based on edge densities between nodes of the knowledge graph;
perform partition-wise encoding using compositional message passing between nodes that enables learning from neighboring nodes in each partition;
generate an embedding for each node and each relation type in each partition based on the partition-wise encoding using compositional message passing, wherein the embedding for each node is based on learned knowledge from neighboring nodes;
concatenate the generated embeddings from the plurality of partitions; and
train a neural network for a downstream prediction task based on the concatenated embeddings using one or more weight matrices.

20. The non-transitory computer readable medium of claim 19, wherein the instructions, when executed by the processor, further programs the processor to:
execute a message passing function having two level message passing;
generate, as an output of the message passing function, a first message composition and a second message composition; and
update the message passing function using an activation function on the first message composition and the second message composition.
